(19) United States
(12) Patent Application Publication
(10) Pub. No.: US 2002/0196709 A1
(43) Pub. Date: Dec. 26, 2002

(54) JAK seasonal calendar system

(76) Inventor: John Anthony Karageorge, Ocean City, MD (US)

Correspondence Address: John A Karageorge, 14137 Sea Captain Road, Ocean City, MD, 21842, US

(21) Appl. No.: 09/986,566

(22) Filed: Nov. 9, 2001

Related U.S. Application Data
(60) Provisional application No. 60/287,708, filed on May 2, 2001.

(51) Int. Cl. G04B 19/24

(52) U.S. Cl. 368/28

(57) ABSTRACT

The Gregorian calendar system is modified by continuing to add a 25^{th} leap year day every four hundred years and then not adding a 25^{th} leap year day every three thousand two hundred years. Then, after 27 cycles of the 3,200 year period, a 25^{th} leap year day is added to align the calendar with the solar year. By doing so, the need for eliminating days from the calendar as is required by the Gregorian calendar as prescribed by Britannica Encyclopedia is avoided.

This patent application claims priority based on provisional patent application No. 60/287,708, filed on May 2, 2001.

### FIELD OF THE INVENTION

The present invention is directed to a calendar system, and in particular to a calendar system that makes up for the shortcomings of the Gregorian calendar.

### BACKGROUND ART

Julius Caesar, on the advice of the Greek, Sosigenes, authorized the use of the Julian calendar in 46 BC (year 709 of Rome.) This system remained in effect for the western world until AD 1582 at which time several countries switched to the Gregorian calendar. St. Bede, the Venerable, an Anglo-Saxon monk, concluded in AD 730 that the Julian year was 11 minutes and 14 seconds longer than the solar year. However, nothing was done to correct for this discrepancy for another 800 years. To make up for the accumulated error in time, Pope Gregory XIII decreed that the day following Oct. 4, 1582 should be Oct. 15, 1582, thus starting the Gregorian calendar.

The Gregorian calendar was first adopted by France, Italy, Spain, Portugal, and Luxembourg. The British government, including the American colonies, switched to the Gregorian calendar in 1752. The day following Sep. 2, 1752 was decreed to be September 14, yielding a loss of 11 days. Under the new Gregorian calendar, New Year's Day was moved from March 25 (Julian calendar) to January 1^{st}.

The problem with the Gregorian calendar is that it does not provide a method of calculating the accurate insertion of the 25^{th} leap year day into a qualifying century yielding the complete solution to the leap year problem.

Another discrepancy inherent in the design of the Gregorian calendar is it gives us two winters every year (January 1-March 20, December 21-December 31).

Leap years are necessary because the solar year is 365 days 5 hours 48 minutes and 46 seconds long. 5 hrs. 48 min. and 46 seconds is 11 minutes 14 seconds short of ¼ day. This equates to 20,926 seconds more than 365 days. In one hundred years, this difference grows to 2,092,600 seconds or 24.2199074 20 days (2,092,600 seconds/86,400 seconds per day=24.2199074 days/century).

The Gregorian calendar currently calculates time at the rate of 24.25 leap year days per century. In two thousand years, this changes to 24.225 days (((30×24)+(10×25)−1)/40=24.225), if we follow the advice of Britannica Encyclopedia. More particularly, a leap year occurs every 4 years starting on the first year of the century. However, century years that are not evenly divisible by 400 (1800, 1900, 2100, etc.) are not leap years for the Gregorian calendar, but they are for the Julian calendar. The Julian calendar has 25 leap year days per century, the Gregorian calendar has 24.25 (0.2199074) leap year days per century . . . ((3×24)+25)/4=24.25 leap year days. Put another way, every four hundred years, there are three century years which do not get a leap year day so those three centuries only have 24 leap days. The fourth century has 25 leap days. When this is averaged over the four centuries, the added time per century is 24.25 days (24.25=(3×24+25)/4).

As can be seen from the above, the Gregorian calendar per century adds 24.25 days whereas the solar year addition over the century is only 24.2199074 days. 24.25 days is greater than 24.2199074 days; therefore, the Gregorian calendar is over compensating causing a deficit of time. 0.2199074 days equates 20 to 19,000 seconds/century. This surplus of 19,000 seconds every 100 years grows to 76,000 seconds in 400 years.

Until now, there has been no solution or method that completes the leap year adjustments bringing closure to the leap year problem and clearly defining an algorithmic cycle. A suggestion by Britannica Encyclopedia reveals the algorithmic scenario “400 years, 4,000 years, 20,000 years . . . ” and works out as follows:

Every 400 years, the Gregorian calendar adds a 25^{th} day for that century, this added day equating to 86,400 seconds. Since we only have to account for the surplus of 76,000 seconds, adding the 25^{th} day every fourth century results in an overcompensation by 10,400 seconds causing a deficit of time. That deficit grows to 104,000 seconds after 4000 years at which time the Gregorian calendar does not add the 25^{th} day. This compensation (omitting the 25 leap year day every 4,000 years) still leaves us with a deficit of 17,600 seconds, which grows to 88,000 seconds in 5 time periods of 4,000 years (20,000 years). So every 20,000 years, not only is the 25^{th} leap year day skipped, another day must be subtracted from our calendar. This process continues exactly this way for 1,080,000 years at which time 2 days are subtracted and then the calendar cycle starts over again.

The obvious problem with the prescribed method by Britannica is that eventually we will be required to eliminate 55 common days throughout the 1,080,000 year life cycle. Such a change may wreak havoc on computer systems, much like the Y2K problem encountered when entering the year 2000.

Thus, a need exists to avoid the necessity of eliminating days from the calendar while still adhering to the Gregorian calendar. The present invention solves this need by providing a calendar system and method of calculation that eliminates the need to cancel days to accommodate the solar year.

### SUMMARY OF THE INVENTION

It is a first object of the present invention to provide an improved calendar system.

Another object of the invention is to provide an improvement in the Gregorian calendar.

Still another object of the invention is a method of modifying the Gregorian calendar by adjusting for overcompensation over a given time period.

Other objects and advantages of the present invention will become apparent as a description thereof proceeds.

The invention is an improvement on the Gregorian calendar and more accurately accounts for the discrepancy in time that occurs due to faulty/incomplete leap year calculations. The Gregorian calendar system adds a 25^{th} leap year day every four 20 hundred years and does not add a 25^{th} leap year day every four thousand years. The improvement comprises a calendar system having a 25^{th} leap year day added every four hundred years, and not adding a 25^{th} leap year day every three thousand two hundred years. The invention also entails a method of generating an improved calendar system wherein a 25^{th} leap year day is added every four hundred years, and a 25^{th} leap year day is not added every three thousand two hundred years. In either the system or the method, after a period of 27 cycles of 3,200 years each (86,400 years total) elapses, a 25^{th} leap year day is added so that the calendar is aligned with the solar year.

The invention also includes specifying that May, June, July, August, and September have 31 days, and the remaining months have 30 days, including February. Other aspects of the invention include celebrating the leap year day on March 31, and shifting April 1^{st} eleven days so that it occurs on what is March 21 of the Gregorian calendar. This will allow the seasons to fall as follows: First day or first full day of Spring—April 1, Summer—July 1, Autumn—usually October 1, and Winter—usually January 1.

### BRIEF DESCRIPTION OF THE DRAWINGS

Reference is now made to the drawings wherein:

The sole FIGURE depicts a chart showing how to account for the overcompensation of the Gregorian calendar using the invented method.

### DESCRIPTION OF THE PREFERRED EMBODIMENTS

The present invention offers a significant solution to make up for the shortcomings that are inherent in the Gregorian calendar system. Typically, leap years are used to make up for the length of the solar year over 365 days. This length is actually 5 hours, 48 minutes, and 46 seconds, or approximately ¼ day. Thus, every four years a day is added to account for the accumulated time over four years. However, 5 hours, 48 minutes, and 46 seconds is actually a little less than a fourth of a day, 11 minutes and 14 seconds less. According to the Gregorian calendar, a 25^{th} leap year day is added every four hundred years, causing a deficit of time.

The outline below depicts an algorithmic scenario of 400 years, 4,000 years, 20,000 years (as suggested by Brittanica Encyclopedia) which more easily shows how the Gregorian calendar creates a deficit, which must be corrected by eliminating days from the year.

### GREGORIAN CALENDAR ALIGNED WITH SOLAR YEAR

Solar Year=365 days 5

$$\begin{matrix}5 hrs . 48 min . 46 sec . = 20 , 926 seconds \\ \underline{\times 100} years \\ \text{surplus seconds} … 2 , 092 , 600\end{matrix}$$

2,092,600/86,400=24.2199074 days per century

.2199074 days=19,000 seconds of surplus

$$\begin{matrix}19 , 000 \times 4 centuries = 76 , 000 \text{surplus seconds} \\ \text{(add} {25}^{th} \text{day)} \underline{ - 86 , 400} \text{(400 years)} \\ - 10 , 400 \text{deficit!} \\ \underline{ \times 10} \text{time periods} \\ - 104 , 000 \text{deficit} \\ \text{(don't add} {25}^{th} \text{day)} \underline{+ 86 , 400} \text{(4,000 years)} \\ - 17 , 600 \text{deficit} \\ \underline{\times 5} \text{time periods} \\ - 88 , 000 \text{deficit} \\ \text{(skip 12/31)} \underline{ + 86 , 400} \text{(20,000 years)} \\ - 1 , 600 \text{deficit} \\ \underline{\times 54} \text{time periods} \\ - 86 , 400 \text{deficit} \\ \text{(skip 12/30)} \underline{ + 86 , 400} \text{(1,080,000 years)} \\ 0 \text{(-55 days)} \end{matrix}$$

Gregorian calendar aligned with solar year.

In other words, over the 1,080,000 year cycle, 55 days are lost when using the Gregorian calendar in a manner suggested by Britannica Encyclopedia.

The invention solves this problem using the following method.

By adding the 25^{th} leap year day every 400 years, and then not adding the 25^{th} leap year day every 3200 years or 8 cycles of four hundred years, we must then add a 25^{th} leap year day at the end of 27 time periods of 3,200 years (86,400 years) so that the surplus of 86,400 seconds is depleted by the addition of the extra 25^{th} leap year day. More particularly, if the 10,400 second deficit that occurs at 400 year intervals in the Gregorian calendar, is allowed to grow for 8 cycles or three thousand two hundred years (3,200), the deficit grows to 83,200 seconds. Then, at that time, i.e., at the 3,200 year interval, the 25^{th} leap year day is not added. This compensation alters the deficit of 83,200 seconds to a surplus of 3,200 seconds. Allowing this scenario to continue for 27 time periods of 3,200 years (86,400 years), the 25^{th} leap year day is added to the calendar, and the calendar is aligned with the solar year.

Put another way, the algorithmic scenario 400 years, 3,200 years, 86,400 years is a vast improvement over the 400 year, 4,000 year, 20,000 year . . . method suggested by Britannica.

Another alternative, but less desirable a method, would be 500 years, 5,000 years, 1,080,000 years; however, this method requires the addition of a 26^{th} leap year day every 5,000 years.

The sole FIGURE depicts a chart, which shows the operative steps and the calculations associated with the inventive method.

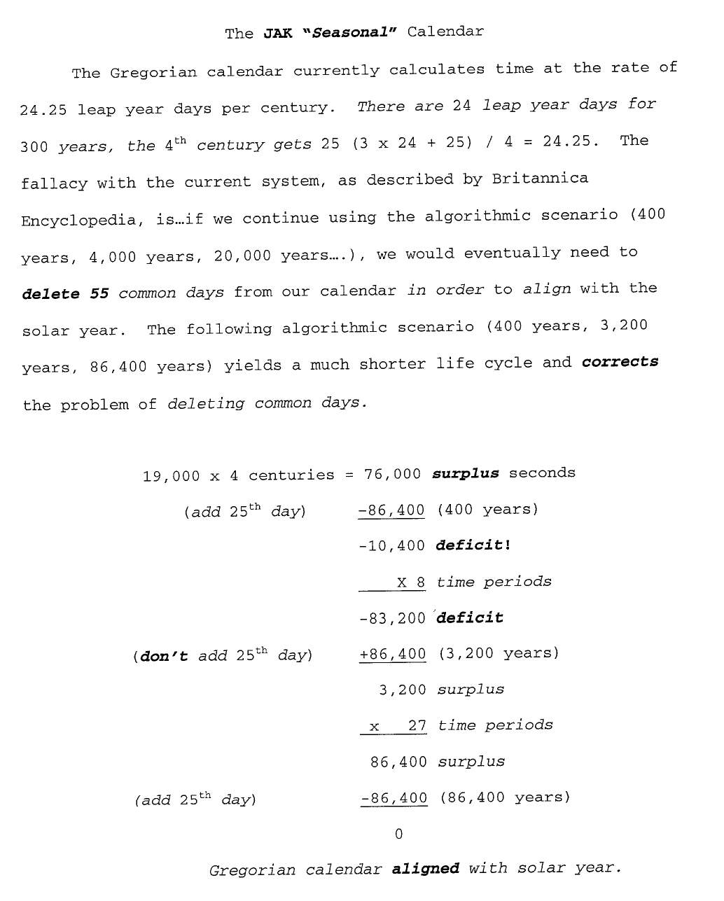

FIG. 1 addresses the invention wherein the surplus after 4 centuries is first addressed by adding the 25^{th} leap year day, and then, after 8-four century time periods have elapsed, the 25^{th} day is not added. Then, 27 periods of the 3,200 year cycle elapse at which time a 25th leap year day is added, and the cycle begins over again.

As with the Gregorian calendar, 24 leap years are added to every century of the seasonal calendar starting on the fifth year of the century, 1904, 2004, etc. and incremented every four years. The “25^{th}” leap year day is added to the first year of the century as determined by the algorithmic scenario of the inventive method.

Another feature of the inventive calendar system is the shifting of April 1^{st} by eleven days to what is known in the Gregorian calendar as March 21. This will allow for the identification of Spring as occurring on April 1 or the preceding day. Then, each season can start on either the 1st of a month or the following day; Summer on July 1, Autumn usually on October 1, and Winter usually on January 1. In addition, May, June, July, August and September have 31 days and all other months have 30 days, including February.

The leap year day will be added as March 31 when required. The first day of the calendar year will start on April 1 rather than January 1 as is conventionally done.

The inventive calendar system also considers the century year as the first year of the century.

As such, an invention has been disclosed in terms of preferred embodiments thereof, which fulfills each and every one of the objects of the present invention as set forth above and provides an improvement in the Gregorian calendar system.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. In a Gregorian calendar system that adds a 25^{th} leap year day every four hundred years and does not add a 25^{th} leap year day every four thousand years, the improvement comprising a calendar system having a 25^{th} leap year day added every four hundred years, and not adding the 25^{th} leap year day every three thousand two hundred years.

2. The calendar system of claim 1, wherein a 25^{th} leap year day is added after 27 time periods of three thousand two hundred years each (86,400 years total).

3. The calendar system of claim 1, wherein each of May, June, July, August, and September have 31 days, and each of January, February, March, April, October, November and December have 30 days.

4. The calendar system of claim 1, wherein April 1^{st} is shifted eleven days to what is March 21^{st} of the Gregorian calendar, thereby allowing for the first day or the first full day of Spring to begin on April 1, Summer to begin on July 1, Autumn to usually begin on October 1, and Winter to usually begin on January 1.

5. The calendar system of claim 1, wherein each leap year day is added as March 31.

6. The calendar system of claim 1, wherein April 1 is the first day of the calendar year.

7. In a method of calculating the Gregorian calendar wherein a 25^{th} leap year day is added every four hundred years, and a 25^{th} leap year day is not added every four thousand years, the improvement comprising adding the 25^{th} leap year day every four hundred years, and not adding the 25^{th} leap year day every three thousand two hundred years.

8. The method of claim 7, wherein a 25^{th} leap year day is added after 27 time periods of three thousand two hundred years each (86,400 years total).

9. The method of claim 7, wherein each of May, June, July, August, and September have 31 days, and each of January, February, March, April, October, November, and December have 30 days.

10. The method of claim 7, wherein April 1^{st} is shifted eleven days to what is March 21^{st} of the Gregorian calendar, thereby allowing for the first day or first full day of Spring to begin on April 1, Summer to begin on July 1, Autumn to usually to begin on October 1, and Winter to usually begin on January 1.

11. The method of claim 7, wherein each leap year day is added as March 31.

12. The method of claim 7, wherein April 1 is the first day of the calendar year.

13. The system of claim 1, wherein 24 leap year days are added to every century beginning on the fifth year of the century, and incremented every four years.

14. The method of claim 7, wherein 24 leap year days are added to every century beginning on the fifth year of the century, and incremented every four years.

15. The system of claim 1, wherein the century year is considered the first year of the century.

16. The method of claim 7, wherein the century year is considered the first year of the century.

17. The system of claim 1, wherein the “25^{th}” leap year day is added to the first year of the century as determined by the calendar system.

18. The system of claim 2, wherein the “25^{th}” leap year day is added to the first year of the century as determined by the calendar system.

19. The method of claim 7, wherein the “25^{th}” the leap year day is added to the first year of the century as determined by the calendar system.

20. The method of claim 8, wherein the “25^{th}” leap year day is added to the first year of the century as determined by the calendar system.
